(19) United States
(12) Patent Application Publication
(10) Pub. No.: US 2005/0163599 A1
(43) Pub. Date: Jul. 28, 2005

(54) Multi-chamber processing system

(75) Inventor: Hae-Gyun Park, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(73) Assignee: Samsung Electronics Co., Ltd.

(21) Appl. No.: 11/015,784

(22) Filed: Dec. 20, 2004

(30) Foreign Application Priority Data
Jan. 26, 2004 (KR) 2004-4629

(51) Int. Cl. B65G 1/00

(52) U.S. Cl. 414/217

(57) ABSTRACT

A multi-chamber processing system for use in manufacturing semiconductor devices allows various ones of the chambers to be disassembled while wafers continue to be processed using the remaining chambers. The multi-chamber processing system includes a load lock chamber, a process chamber, and a transfer chamber through which wafers are transferred between the load lock and process chambers, and a respective pair of gates interposed between the load lock chamber and the transfer chamber and between the transfer chamber and the process chamber. The manufacturing process can continue uninterrupted when the process chamber is cleaned or when one of the load lock and process chambers must be repaired.

### BACKGROUND OF THE INVENTION

1. Field of the Invention

The present invention relates to equipment for manufacturing a semiconductor device. More particularly, the present invention relates to a multi-chamber processing system that includes loadlock, transfer and process chambers for manufacturing a semiconductor device.

2. Description of the Related Art

Currently, the manufacturing of semiconductor devices generally involves fabricating minute integrated circuits (IC) by subjecting a wafer having a large diameter to a highly precise and complicated process. To this end, a multi-chamber processing system has become a significant tool in carrying out such a complex process on wafers while providing a high throughput. A conventional multi-chamber processing system comprises a plurality of vacuum chambers and a transfer chamber for transferring a wafer between the vacuum chambers. The vacuum chambers are connected with the transfer chamber via gate valves.

A conventional multi-chamber processing system is illustrated in FIG. 1. The conventional multi-chamber processing system comprises first and second load ports 10, 12 by which wafers are loaded into the system, a front end system 20 including an ATM robot 22 for transferring the wafers and an ATM aligner 24 for aligning each wafer transferred by the ATM robot 22, first and second load lock chambers 30, 32, first and second process modules 50, 52, a transfer chamber 40, and a robot 42 having a vacuum chuck disposed in the transfer chamber. The first and second load lock chambers 30, 32 include shelf units. The ATM robot 22 transfers wafers from the first and second load pots 10, 12 to t he ATM aligner 34, and onto the shelf units of the load lock chambers 30, 32. The robot 42, on the other hand, transfers the wafers between the process modules 50, 52 and the first and second load lock chambers 30, 32.

More specifically, first, the ATM robot 22 transfers a wafer from the first port 10 or the second load port 12 to the ATM aligner 24. Then, the ATM aligner 24 aligns the wafer with the first or second process modules 52, 54. Next, the ATM robot 22 transfers the aligned wafer onto the shelf unit of the first or second load lock chamber 30, 32. This process is repeated until all of the wafers are transferred from the first and second load ports 10,12 into the first and second load lock chambers 30, 32. The first and second load lock chambers 30, 32 are sealed and then evacuated to prevent any impurities from entering the chambers 30, 32. Then, the robot 42 transfers a wafer from the shelf unit of the first or second load lock chamber 30, 32 to the first or second process module 50, 52. Once the processing of the wafer is completed in the process module 50, 52, the wafer is transferred onto the shelf unit of the first load lock chamber 30 or the second load lock chamber 32 by the robot 42. Then the first load lock chamber 30 or the second load lock chamber 32 is vented. Subsequently, the doors of the first and second load lock chambers 30, 32 are opened, and wafers are transferred by the ATM robot 22 from the first and second load lock chambers 30, 32 to the shelf units of the first load port 10 and the second load port 12. A number of wafers are processed by repeatedly performing these operations.

FIG. 2 illustrates another conventional multi-chamber processing system. This conventional multi-chamber processing system comprises first and second load lock chambers 60, 62 having shelf units, first, second and third process chambers 80, 82, 84, a transfer chamber 70 through which wafers are transferred by a robot between the process chambers 80, 82 and 84 and the first and second load lock chambers 60, 62, first and second inner gates 64, 66 that separate the first and second load lock chambers 60, 62 from the transfer chamber 70, respectively, and third, fourth and fifth inner gates 72, 74, 76 that separate the first, second and third process chambers 80, 82, 84 from the transfer chamber 70, respectively.

The conventional processing system shown in FIG. 2 operates as follows. First, a wafer is transferred into the first load lock chamber 60 or the second load lock chamber 62. At this time, the first or second load lock chamber 60, 62 have been evacuated to prevent any impurities from remaining in them. Next, the first inner gate 64 and the third inner gate 72 are opened by a controller (not shown). The wafer is transferred from the shelf unit of the first load lock chamber 60 into the first process chamber 80 by the transfer robot disposed in the transfer chamber 70. The first inner gate 72 is then closed by the controller whereupon the wafer is processed in the first process chamber 80. Once the processing of the wafer has been completed, the controller opens the first inner gate 72 and the transfer robot transfers the processed wafer onto the shelf unit of the first load lock chamber 60. A number of wafers are processed by repeatedly performing these operations. Also, although an operation involving the first load lock chamber 60 and the first process chamber 80 has been described, similar operations are carried out involving the second load lock chamber 62 and the second and third process chambers 82, 84.

In the above-described conventional multi-chamber processing system, the operations of the whole system are stopped from time to time to repair or clean one or more of the process chambers. For example, a problem may arise in one of the chambers or a chamber might need to be mechanically cleaned to remove particles that have accumulated therein as the result of film-forming processes carried out on the wafers. In these cases, the process chamber in question is separated from the transfer chamber so that it can be disassembled and examined or cleaned. However, this opens a port in the transfer chamber at a location where the process chamber has been separated therefrom. Accordingly, it becomes impossible to use the transfer chamber. Consequently, it is also impossible to operate the other process chambers. That is, the convention multi-chamber processing system h s a drawback in that the operation of the entire system must be stopped if there is a problem in any one of the process chambers. Thus, the productivity is severely limited.

### SUMMARY OF THE INVENTION

Therefore, an object of the present invention is to substantially obviate one or more problems, limitations and disadvantages of the prior art.

More specifically, one object of the present invention is to provide a multi-chamber processing system that can operate with a high degree of productivity.

Another object of the present invention is to provide a multi-chamber processing system by which specific chambers can be repaired or cleaned without the need to stop the operation of the entire system.

The foregoing and other objects and advantages are realized by providing a multi-chamber processing system having a dual assembly of gates (e.g., gate valves) interposed between each load lock chamber and a transfer chamber and between the transfer chamber and each process chamber.

According to one aspect of the invention, preferably inner gate of the dual gate assembly associated with each process chamber is installed at the side (exit) of the transfer chamber, thereby making it possible to separate one or more process chambers from the transfer chamber without the need to stop the manufacturing operation in its entirety.

According to another aspect of the invention, preferably the inner gate of the dual gate assembly associated with each load lock chamber is installed at the side (entrance) of the transfer chamber, thereby making it possible to separate one or more load lock chambers from the transfer chamber without the need to stop the manufacturing operation in its entirety.

In accordance with another aspect of the invention, a respective gate assembly detachably connects each load lock chamber to the transfer chamber, and each process chamber to the transfer chamber. Each of the gate assemblies includes a respective inner gate fixed to the transfer chamber so that each of the load lock and process chambers can be disassembled from the transfer chamber while the respective inner gates remained fixed thereto. Accordingly, the system can remain in operation when any of the load lock and process chambers is disassembled from the transfer chamber via a gate assembly.

The inner gate assembly that detachably connects a load lock chamber to the transfer chamber further comprises a passageway extending between the transfer chamber and the loadlock chamber, and an outer gate located at an exit of the load lock chamber. Likewise, each gate assembly that detachably connects a process chamber to the transfer chamber further comprises a passageway extending between the transfer chamber and the process chamber, and an outer gate located at an entrance of the process chamber. The passageways have outside walls made of aluminum, and inside walls made of quartz.

### BRIEF DESCRIPTION OF THE DRAWINGS

The above and other objects, features and advantages of the present invention will become more apparent to those of ordinary skill in the art from the following detailed description of the preferred embodiments thereof made with reference to the attached drawings in which:

FIG. 1 is a schematic diagram of a conventional multi-chamber processing system;

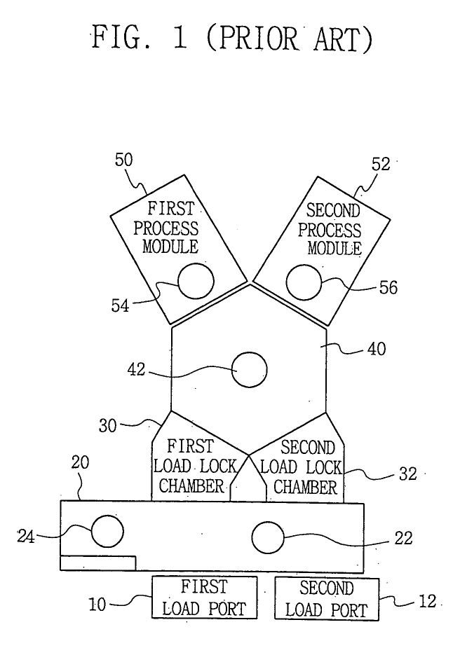

FIG. 2 is a schematic diagram of another conventional multi-chamber processing system; and

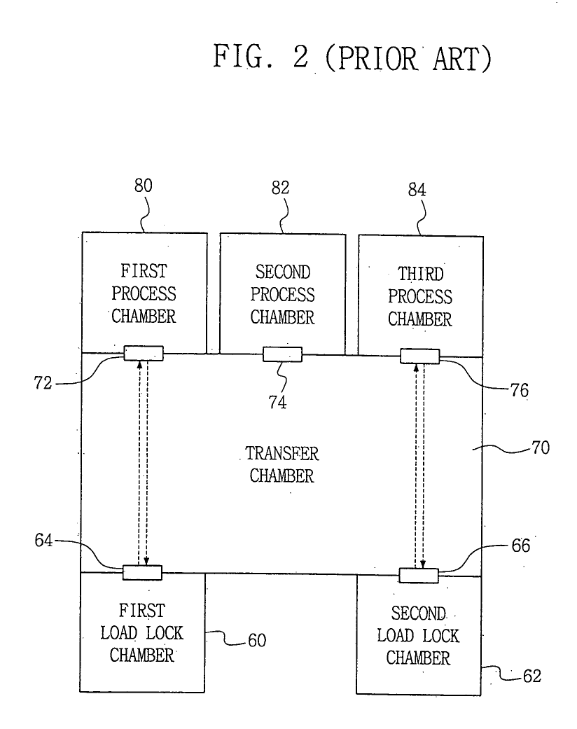

FIG. 3 is a schematic diagram of a multi-chamber processing system according to the present invention.

### DETAILED DESCRIPTION OF THE PREFERRED EMBODIMENTS

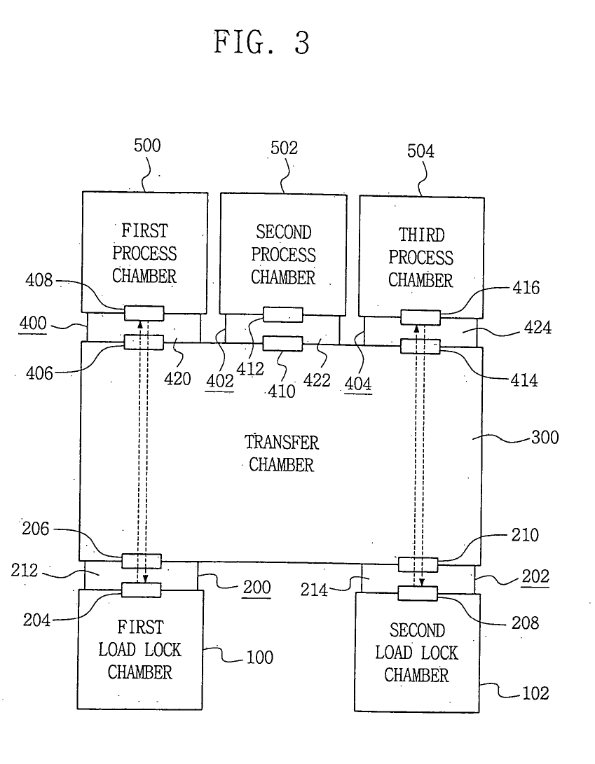

The present invention now will be described more fully hereinafter with reference to FIG. 3.

The multi-chamber processing system of the present invention comprises first and second load lock chambers 100, 102 each containing a shelf unit, first, second and third process chambers 500, 502, 504 for processing wafers, respectively, a transfer chamber 300 containing a transfer robot for transferring the wafers between the process chambers 500, 502 and 504 and the load lock chambers 100, 102, first and second gate assemblies 200, 202 that separate the load lock chambers 100, 102 from the transfer chamber 300, respectively, and third, fourth and fifth inner gate assemblies 400, 402, 404 that separate the process chambers 500, 502, 504 from the transfer chamber 300, respectively. The first gate assembly 200 detachably couples the first load lock chamber 100 to the transfer chamber 300 and comprises first and second (outer and inner) gates 204, 206, and a connection unit 212. The second gate assembly 202 detachably couples the second load lock chamber 102 to the transfer chamber 300 and comprises third and fourth (outer and inner) gates 208, 210, and a connection unit 214. The third gate assembly 400 detachably couples the first process chamber 500 to the transfer chamber 300 and comprises fifth and sixth (inner and outer) gates 406, 408, and a connection unit 420. The fourth gate assembly 402 detachably couples the second process chamber 502 to the transfer chamber 300 and comprises seventh and eighth (inner and outer) gates 410, 412, and a connection unit 422. The fifth gate assembly 404 detachably couples the third process chamber 504 to the transfer chamber 300 and comprises ninth and tenth (inner and outer) gates 414, 416, and a connection unit 424. The inner gates 206, 210, 406, 410 and 414, though, remain fixed to the transfer chamber 300 during the disassembly of any of the load lock or process chambers.

The first and second gates 204, 206 are respectively located at an exit of the first load lock chamber 100 and an entrance of the transfer chamber 300 through which a wafer can pass. Also, the first and second gates 204, 206 are operable to open and close the exit of the first load lock chamber 100 and the entrance of the transfer chamber 300. The third and fourth gates 208, 210 are respectively located at an exit of the second load lock chamber 102 and an entrance of the transfer chamber 300 through which a wafer can pass. Also, the third and fourth gates 208, 210 are operable to open and close the exit of the second load lock chamber 200 and the entrance of the transfer chamber 300. The fifth and sixth gates 406, 408 are respectively located at an exit of the transfer chamber 300 and an entrance of the first process chamber 500 through which a wafer can pass. Also, the fifth and sixth gates 406, 408 are operable to open and close the exit of the first process chamber 500 and the entrance of the transfer chamber 300. The seventh and eighth gates 410, 412 are respectively located at an exit of the transfer chamber 300 and an entrance of the second process chamber 502 through which a wafer can pass. Also, the seventh and eighth gates 410, 412 are operable to open and close the exit of the first process chamber 502 and the entrance of the transfer chamber 300. The ninth and tenth gates 414, 418 are respectively located at an exit of the transfer chamber 300 and an entrance of the third process chamber 504 through which a wafer can pass. Also, the ninth and tenth gates 414, 418 are operable to open and close the exit of the first process chamber 504 and the entrance of the transfer chamber 300.

The connection units 212, 214, 420, 422, 424 comprise passageways that connect the load lock chambers 100, 102 to the transfer chamber 300 and connect the process chambers 500, 502, 504 to the transfer chamber 300, respectively. The outer wall of each of the connection units 212, 214, 420, 422, 424 comprises aluminum, whereas the inner wall (right and left and upper walls) thereof are made of quartz.

An operation of the multi-chamber processing system of the present invention will now be described in detail.

A wafer is transferred into the first load lock chamber 100 or the second load lock chamber 102. At this time, a door of the first or second load lock chamber 100,102 is closed by a controller and the first or second load lock chamber 100, 102 is vented so a s to be evacuated. Here, an operation involving the first load lock chamber 100 and the first process chamber 500 will be described below. Once the vacuum is created in the first load lock chamber 100, the first and second gate 204, 206 and the fifth and sixth gates 406, 408 are opened by the controller. Then, the wafer is transferred from the shelf unit of the first load lock chamber 100 into the first process chamber 500 by the transfer robot disposed in the transfer chamber 300. The fifth and sixth gates 406, 408 are then closed and the wafer is processed in the first process chamber 500 under the command of the controller. Once the processing of the wafer has been completed, the fifth and sixth gates 406, 408 are opened, and the processed wafer is transferred onto the shelf unit of the first load lock chamber 100 by the transfer robot in the transfer chamber 300. A number of wafers are processed by repeatedly performing these operations. At the same time, similar operations are performed involving the second load lock chamber 102 and the second and third process chambers 502, 504.

Now, if the second process chamber 502 needs to be cleaned, e.g., if an excessive amount of polymer has adhered to the eighth gate 412, the seventh gate 410 is closed and the eighth gate 412 is opened by the controller. Then, a technician disassembles the second process chamber 502 and cleans the eighth gate. Regardless, the first and third process chambers 500, 504 can be operated while the eighth gate 412 is being cleaned because the seventh (inner) gate 410 remains fixed to the transfer chamber 300.

Furthermore, if a problem arises in the first load lock chamber 100, for example, the problem can also be attended to without stopping the operation of the entire system. More specifically, the first gate 204 is opened, the second inner gate 206 is closed and the first load lock chamber 100 is disassembled so that it can be repaired. Likewise, if a problem occurs in the second load lock chamber 102, the second load lock chamber 102 can be repaired without stopping the operation of the entire system. In this case, the third gate 208 is opened, the fourth inner gate 210 is closed, and the second load lock chamber 102 is disassembled so that it can be repaired.

As described in detail above, the semiconductor manufacturing equipment of the present invention has dual gates interposed between each load lock chamber and the transfer chamber and between the transfer chamber and each process chamber. Accordingly, any one of the load lock or process chambers can be cleaned or repaired without the need to shut down the entire system. Thus, the overall manufacturing process can be carried out with a high degree of productivity.

Finally, although the present invention has been described above in connection with the preferred embodiments thereof, it is to be understood that the present invention is not so limited. Rather, various changes to and modifications of these preferred embodiments are within the true spirit and scope of the invention as defined by the appended claims.

1. A multi-chamber processing system comprising: at least one load lock chamber; at least one process chamber; a transfer chamber interposed between said at least one load lock chamber and said at least one process chamber; a respective pair of inner gates interposed between each said load lock chamber and said transfer chamber; and a respective pair of gates interposed between said transfer chamber and each said process chamber.

2. The multi-chamber processing system according to claim 1, wherein one of the gates of each said pair is located on an exit of the transfer chamber.

3. The multi-chamber processing system according to claim 1, wherein one of the gates of each said pair interposed between each said load lock chamber and said transfer chamber is located at an exit of a said load lock chamber.

4. The multi-chamber processing system according to claim 1, wherein one of the gates of each said pair interposed between said transfer chamber and each said process chamber is located at an entrance of a said process chamber.

5. A multi-chamber processing system comprising:
at least one load lock chamber;
at least one process chamber in which a substrate is processed;.
a transfer chamber interposed between said at least one load lock chamber and said at least one process chamber, and a transfer robot disposed in said transfer chamber and having a working envelope encompassing said at least one load lock chamber and said at least one process chamber so as to transfer substrates between said load lock and process chambers;
a respective gate assembly detachably connecting each said load lock chamber to the transfer chamber, and each said the process chamber to the transfer chamber, each of said gate assemblies comprising a respective inner gate fixed to said transfer chamber, wherein each of said load lock and process chambers can be disassembled from said transfer chamber while the respective inner gates remained fixed thereto, whereby the system can remain in operation when any of said load lock and process chambers is disassembled from said transfer chamber via a said gate assembly.

6. The multi-chamber processing system according to claim 5, wherein each said gate assembly detachably connecting a said load lock chamber to the transfer chamber further comprises a passageway extending between said transfer chamber and the loadlock chamber, and an outer gate located at an exit of the load lock chamber, and each said gate assembly detachably connecting a said load process chamber to the transfer chamber further comprises a passageway extending between said transfer chamber and the process chamber, and an outer gate located at an entrance of the process chamber.

7. The multi-chamber processing system according to claim 6, wherein the passageway of each said connection unit comprises an wall of aluminum and an inner wall of quartz.
